(19) United States
(12) Patent Application Publication
(10) Pub. No.: US 2020/0262080 A1
(43) Pub. Date: Aug. 20, 2020

(54) COMPREHENSIVE MODEL-BASED METHOD FOR GANTRY ROBOT CALIBRATION VIA A DUAL CAMERA VISION SYSTEM

(71) Applicant: InTune Products LLC, Webster, NY (US)

(72) Inventors: Mostafa Ghobadi, Webster, NY (US); Aliakbar Alamdari, Webster, NY (US)

(73) Assignee: InTune Products LLC, Webster, NY (US)

(21) Appl. No.: 16/791,195

(22) Filed: Feb. 14, 2020

Related U.S. Application Data
(60) Provisional application No. 62/805,563, filed on Feb. 14, 2019.

(51) Int. Cl. B25J 9/16

(52) U.S. Cl. CPC B25J 9/1692; B25J 19/023; B25J 9/1697

(57) ABSTRACT

A comprehensive model-based mathematical method for calibration of a gantry robot and a tool via a dual camera vision system may employ an automatic calibration process that includes: (i) Camera Internal and External Calibration (ULC and DLC), (ii) Camera Installation, (iii) Robot Workspace Calibration, and (iv) Tool Calibration. The method may provide an accurate, fast and affordable method for robot calibration which may significantly reduce the commissioning time, such that the time-consuming, cumbersome, conventional trial-and-error method may be reduced to a time-efficient automatic procedure with no human interference.

The present application claims the benefit of U.S. Provisional Patent Application No. 62/805,563, filed Feb. 14, 2019, which is hereby incorporated by reference in its entirety.

### FIELD OF THE INVENTION

This manuscript focuses on a comprehensive model-based mathematical method for calibration of the gantry robot via dual camera vision system. We assume the axes of gantry system have angular misalignment in the horizontal plane i.e. the axes are not perfectly perpendicular to each other. Moreover, the axes are linearly scaled in X-axis and Y-axis with unknown scaling factor. Also, we assume the upward looking camera (ULC) and downward looking camera (DLC) are installed with minute angles on the gantry system. We presume the axes of camera view are perpendicular to each other but they are not perfectly aligned with the XY axes of the reference plate. It is also assumed that the tooling system is installed with some misalignment on X-axis of gantry system such that the tool axis has slight angles with the normal planes to the reference plate. The method presented in this manuscript can provide a sufficiently accurate, fast and affordable method for calibration of a gantry robot. Implementing this approach significantly reduces the commissioning time, such that the time-consuming trial-and-error method in manufacturing floor will be significantly reduced to multi-step automatic procedure with no human interference

### BACKGROUND OF THE INVENTION

Robotic systems have become increasingly important in manufacturing of devices. These systems can perform repeated task with more accuracy and efficiency than human labor. These robots can be used in manufacturing of products such as medical devices, smart gadget, etc. with small components which picking and placing of those components are undesirable for human labor. The accuracy and precision level of assembling of the product components are directly related to the accuracy of the robotic system which is primarily built for assembling purposes. In the design of any basic or complicated assembling machine some accuracy requirements are inevitably considered in advance, which must be met in the design process to yield a reliable and accurate assembled product. To maintain the predefined machine accuracy within an acceptable range, the calibration process must be accomplished. Eliminating or minimizing the factors that cause inaccuracy in the machine motion is a fundamental aspect of machine calibration.

Conventionally, calibration regime is performed using some calibrators to establish the correlation between the motion by machine and known moved values. This time-consuming process, in essence, teaches the machine to produce more accurate results than those that would occur otherwise. Therefore, providing a method which could minimize the time spent, and at the same time improve the accuracy of the machine and establish reliable post-calibration results, would be advantageous.

U.S. Pat. No. 8,180,487 describes a method of calibrating a vision-based robotic system. The approach is based on the trial-and-error to calibrate the gantry system. This method moves the calibration pin to a calibration block that includes one set of optical transmitter-receiver to receive beam. This method moves the calibration pin to the center point of the transmitted optical beam to determine a camera center position. This approach does not establish a mathematical model to consider misalignments and scaling of the gantry system, camera installation error, tool misalignment in the system.

The method presented in U.S. Pat. No. 7,627,395 is also based on the trial-and-error to calibrate the gantry system. It moves a calibration wafer supported by a robot to a reference position within the semiconductor processing system; viewing the calibration wafer to obtain wafer position data; and utilizing the wafer position data to correct the reference position. The method presented in U.S. Pat. No. 6,816,755 uses a tool and one camera mounted on the robot and at least six target features which are normal features of the object are selected. The features are used to train the robot in the frame of reference of the object so that when the same object is subsequently located, the robot's path of operation can be quickly transformed into the frame of reference of the object.

There are some robot calibration methods based on the geometry for a 6-degrees-of-freedom (DOF) robot manipulator. For example, one calibration device uses three laser beams. The coordinates of the laser spots on the table in the world coordinate system is obtained by processing the image data on a CCD camera fixed above. Based on that, the mapping between the world coordinate system and the robot base coordinate system can then be utilized to locate the robot within its environment by some geometric analysis.

In U.S. Pat. No. 8,135,208, a method for calibrating a vision based robotic system is presented. The machine includes two cameras, a calibration gauge with an alignment mark, and a robotic tool with an alignment fiducial. In this method, both camera center positions are determined using camera and the calibration block, and then using the second camera and the robotic tool to determine a robotic tool center position, and calculating a first camera to tool offset value.

A camera-based auto-alignment process for robotic arm is presented in United States Patent Publication 2014/0100694. The gripper unit and camera unit are aligned on two roughly parallel axes. The images are analyzed to calibrate the axis of view of the camera with the gripper axis, providing an XY calibration of the robotic arm. The gripper unit is calibrated on a Z-axis using optical calibration with landmarks provided on a second calibration gauge, by moving the gripper unit towards the work surface until it makes contact with the work surface. Once calibrated, the camera can be used to identify one or more landmarks at known locations on the work surface to align the robotic arm with the work surface.

### SUMMARY OF THE INVENTION

This manuscript focuses on a comprehensive model-based mathematical method for calibration of the gantry system via the machine vision. The method presented in this manuscript can provide a sufficiently accurate, fast and affordable method. In this manuscript we assume the axes of gantry system have angular misalignment α and β radians in the horizontal plane and, and the movement in X and Y axes are scaled by Sₓ,S_{y} in X-axis and Y-axis, respectively. Moreover, the cameras are installed with minute angles on the gantry system. Therefore, the axes of camera view which are perpendicular to each other are not aligned perfectly with the reference plate axes. It is also assumed that the tool is installed with some deviation on x-axis of gantry system such that the tool axis has slight angles with the normal planes to the reference plate.

Our approach focuses on a comprehensive model-based mathematical method for calibration of the gantry system and tool via the machine vision. The method presented in this manuscript can provide a sufficiently accurate, fast and affordable method. Implementing this approach significantly reduce the commissioning time.

### BRIEF DESCRIPTION OF THE DRAWINGS

FIG. 1 is a perspective view of gantry robotic system suitable for use within an embodiment of the present invention;

FIG. 2 is an overhead schematic view of the gantry robotic system shown in FIG. 1, along with associated coordinate systems, in accordance with an aspect of the present invention;

FIG. 3 is a side schematic view of the gantry robotic system shown in FIG. 1;

FIG. 4 is an overhead schematic view of the camera installations of the upward looking camera (ULC) and downward looking camera (DLC) used within the gantry robotic system shown in FIG. 1;

FIG. 5 is a schematic view of a tool installation within the gantry robotic system shown in FIG. 1 along the x axis;

FIG. 6 is a schematic view of a tool installation within the gantry robotic system shown in FIG. 1 along they axis;

FIG. 7 is a schematic view of a representation of a mathematical method used for geometric calibration of the camera to obtain the internal and external parameters of the camera in accordance with an aspect of the present invention;

FIG. 8 is a flow diagram of the mathematical method shown in FIG. 7;

FIG. 9 is a screenshot of an exemplary result of internal and external calibration of camera using the method shown in FIGS. 7 and 8;

FIG. 10 is an exemplary schematic representation of the axes of the gantry robot having angular misalignment α and β radians with respect to the world coordinate system in the horizontal plane;

FIG. 11 is an exemplary schematic representation of the downward looking camera installation with angle γ₁ radians with respect to X-axis of the gantry robotic system as shown in FIG. 4; and

FIG. 12 is an exemplary schematic representation showing movement of the camera center along the X-Y axis for Δx, Δy to find the offset between camera center and tool head center in the gantry robotic system as shown in FIG. 4.

### DETAILED DESCRIPTION OF THE PREFERRED EMBODIMENTS

### Gantry Robot

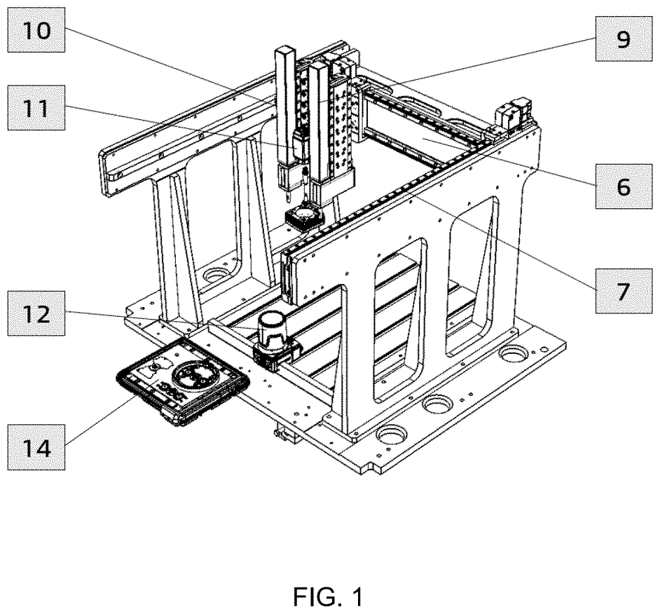

The close-up perspective view of gantry robotic system which is designed for assembling of products with tight tolerances in micrometer-level accuracy is illustrated in FIG. 1. It is assumed that the axes of the gantry robot have angular misalignment α and β radians with respect to the world coordinate system in the horizontal plane. Moreover, the axes are scaled by Sₓ,S_{y} in x-axis and y-axis, respectively.

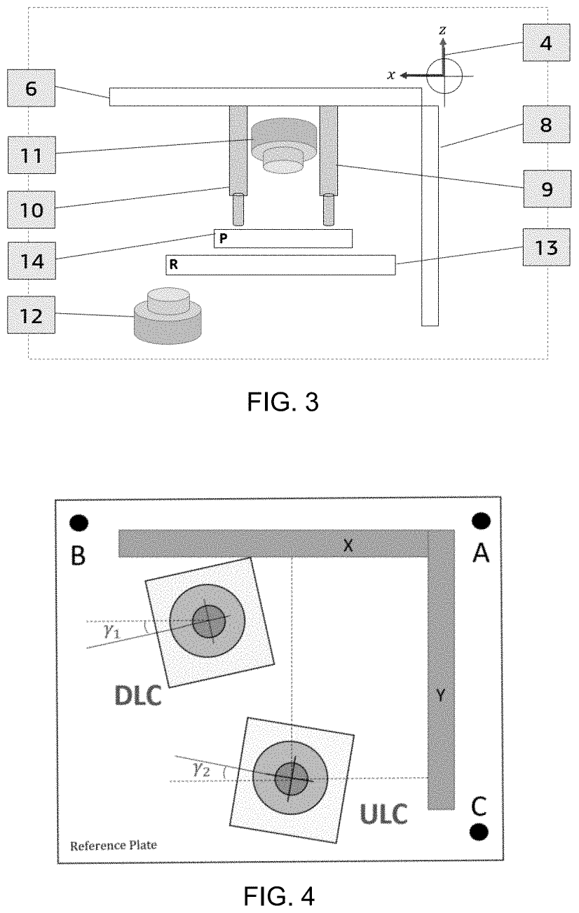

In the following, various embodiments of the invention will be described in detail. Such details are included to facilitate understanding and implementing of the invention. In order to find the above-mentioned unknown parameters in gantry robot, multiple coordinate systems including {C}, {G″}, {G′}, {G} and {W} are established. The coordinate {C} is camera coordinate system which is established at the center of camera with perfectly perpendicular X-Y axes; the coordinate {G} is gantry robot coordinate system; {W} is world coordinate system, and coordinates {G″}, {G′} are medium coordinate systems between {G} and {W}. As shown in FIGS. 1-3, different portions of the robotic system are introduced here:
[1] World coordinate system—Origin
[2] World coordinate system—X axis
[3] World coordinate system—Y axis
[4] World coordinate system—Z axis
[5] Gantry coordinate system—Origin
[6] Gantry system—X axis
[7] Gantry System—Y axis
[8] Gantry system—Z axis
[9] Gantry system Z axis—Head 1
[10] Gantry system Z axis—Head 2
[11] Downward Looking Camera (DLC)
[12] Upward Looking Camera (ULC)
[13] Reference plate for calibration
[14] Part
[15] Precision-points A, B, C on the reference plate
[16] The location of precision-points in camera coordinate system {C}
[17] Dot-grid for calibration
[18] Tapered calibration gauge block

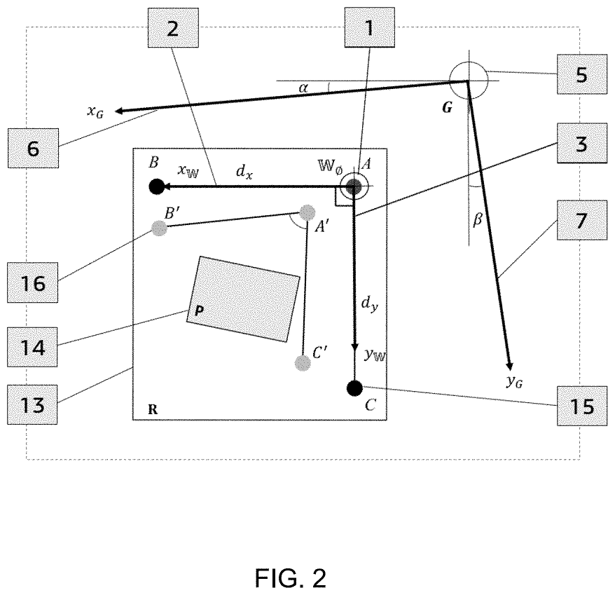

In the gantry robot, two cameras are used for calibration, DLC and ULC. The upward looking camera (ULC), indexed with number (12), is installed with angle γ₂ and downward looking camera (DLC), indexed with number (11), is installed with angle γᵢ radians with respect to X-axis of the gantry system as shown in FIG. 4. Moreover, it is assumed that the axes of camera view which are perpendicular to each other are not perfectly aligned with the reference plate, indexed with number (13) in FIG. 2.

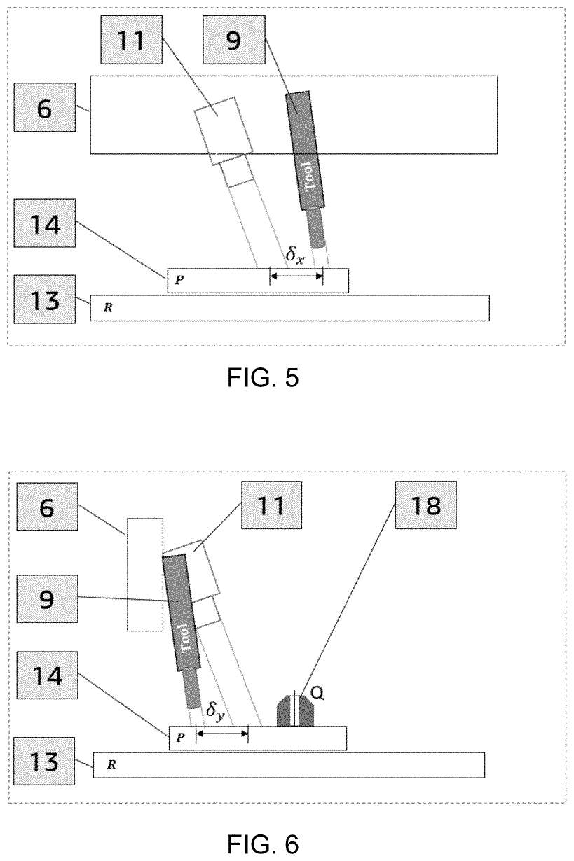

It is also presumed that the tool is installed with slight angle on the gantry system such that the relative distance between end of the tool and camera view center is δₓ in X-axis and δ_{y} in Y-axis, as shown in FIG. 5 and FIG. 6. In the tool calibration section, we introduce a mathematical approach for tool calibration to find unknown parameters δₓ, δ_{y}.

A comprehensive model-based mathematical method for calibration of the gantry system and the tool via the machine vision is developed here. In this automatic calibration process we determine the following parameters which are the main causes of inaccuracy in positioning and assembling of the components:
Camera Internal and External Calibration (ULC and DLC)
   a. Single-Plane Camera Internal Calibration:
      1. The image is captured and undistorted just on single plane. Then, it will map the distances in pixel to millimeter.
   b. Multi-Plane Camera Internal Calibration
      1. The image is captured and undistorted on multiple planes separately.
   c. Single-Plane Camera External Calibration
      1. The image is captured and undistorted just on single plane. Nine points are selected evenly from the camera FOV on the Dot-grid calibration plate, and then the optimized value for mapping between pixels to millimeter is calculated.
   d. Multi-Plane Camera External Calibration
      1. The image is captured and undistorted on multiple planes. Nine points are selected evenly from the FOV of the camera on the Dot-Grid calibration plate on each plane, and then the optimized value for mapping between pixels to millimeter is calculated. The scaled value at first plane is S₁ and in the second plane is S₂. With assumption of linearity of scaling in different planes, for any given working distance between or outside of these planes, the linear interpolation or extrapolation method can be implemented to calculate the scale value S for the given working distance Z. This optimized scale value S is the map between pixels to millimeter at the given working distance Z.
Camera Installation
The DLC and ULC cameras are installed with angle γ₁,γ₂ radians with respect to x-axis of the gantry system. Also, it is assumed the position of ULC camera has not been precisely determined. In this part of the calibration we determine:
   a. Downward Looking Camera (DLC) installation angle γ₁
   b. Upward Looking Camera (ULC) installation angle γ₂
   c. The exact position of ULC camera with respect to gantry coordinate system
Robot Workspace Calibration
Here we assume the axes of gantry system have angular misalignment α and β in horizontal plane in radians as shown in following figure, and also they are scaled by Sₓ, S_{y} in x-axis and y-axis respectively. In this step of the calibration the goal is to calculate:
   a. X and Y axes misalignment using camera
   b. Scaling Factor of the motion system in X and Y axes
For example, the commanded value for positioning of linear motor along the X-axis is 100 mm but the gantry moves to 100.1 mm, then commanded value for positioning becomes 200 mm but the gantry instead of expected position of 200.1 mm, it moves to 200.15 mm. This means that there is scaling factor along the X-axis.
Tool Calibration
It is also assumed that the tool is installed with some deviation on x-axis of gantry system such that the tool axis has small angles with the normal planes to the reference plate. The main concern here is to find:
   a. The relative distance between the center of DLC camera FOV and tool head center. The relative distance in X and Y axes are δₓ and δ_{y}, respectively.
The relative distance between the center of camera FOV and center of tool head is shown in the following figures.

In the next following sections, a mathematical approach is employed and a solution for finding these unknown parameters of gantry robot is described in detail.

### Camera Internal and External Calibration

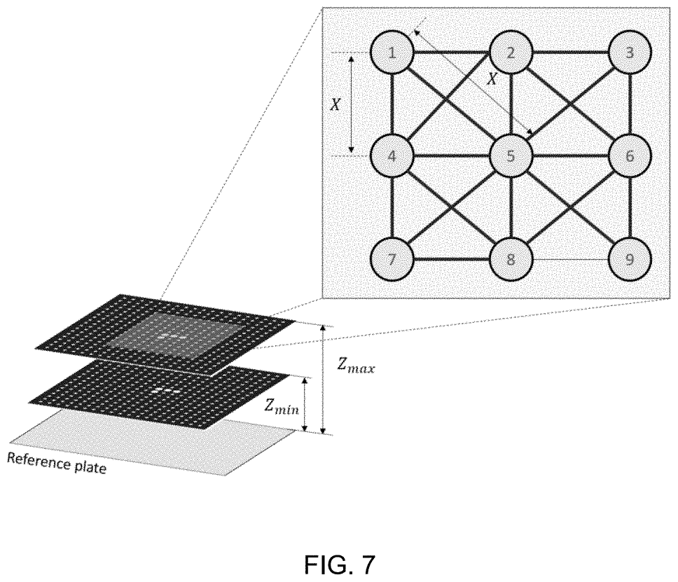

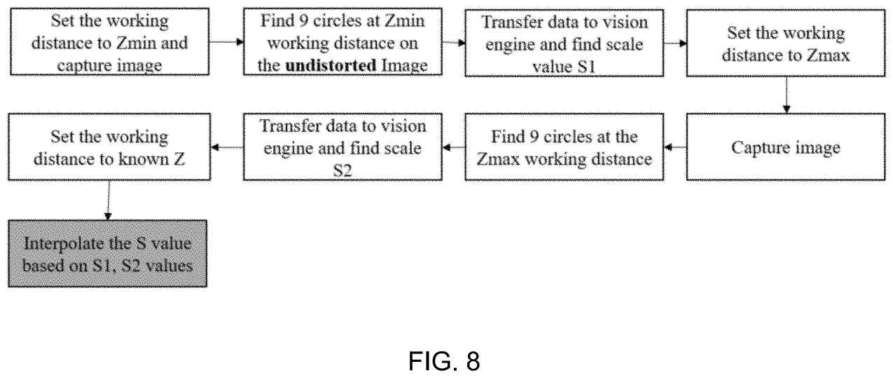

In this section, with reference to FIGS. 7-8, a mathematical method is used for geometric calibration of the camera to obtain the internal and external parameters of the camera. These internal and external parameters maps the X-Y dimensions in the camera coordinate system into the real-world coordinate system. To do so, let us set the working distance between camera lens and Dot-grid to Zₘᵢₙ and capture the image. The internal calibration algorithm inside the vision software maps the pixel distance between dots into the real distance between points in mm, and also, it will undistort the image. Then, the position of nine circles on the dot grid with respect to the center of undistorted image in mm scale is captured and calculated. As shown in FIG. 7, with the help of these nine points, it is possible to build 20 distances between dot points. The scale value S₁ is defined and calculated as follows:

Y_{1×20}=S₁X_{1×20}

S₁=(X^{T}X)⁻¹X^{T}Y (1)

where X is the distance between two dots on the Dot-grid as given by manufacturer and Y is the measured distance between two dots on the Dot-grid in mm.

Again, set the working distance between camera lens and Dot-grid to Zₘₐₓ and capture the image. Then, with the help of above-mentioned nine points and 20 distances between these points, the value of S₂ can be calculated as:

S₂=(X^{T}X)⁻¹X^{T}Y (2)

Finally, set the working distance to Z and find the scale value S based on the Zₘₐₓ, Zₘᵢₙ and S₁, S₂ with linear interpolation/extrapolation as:

$$S = \frac{{S}_{1} - {S}_{2}}{{Z}_{max} - {Z}_{min}} ( Z - {Z}_{min} ) + {S}_{1} \qquad ( 3 )$$

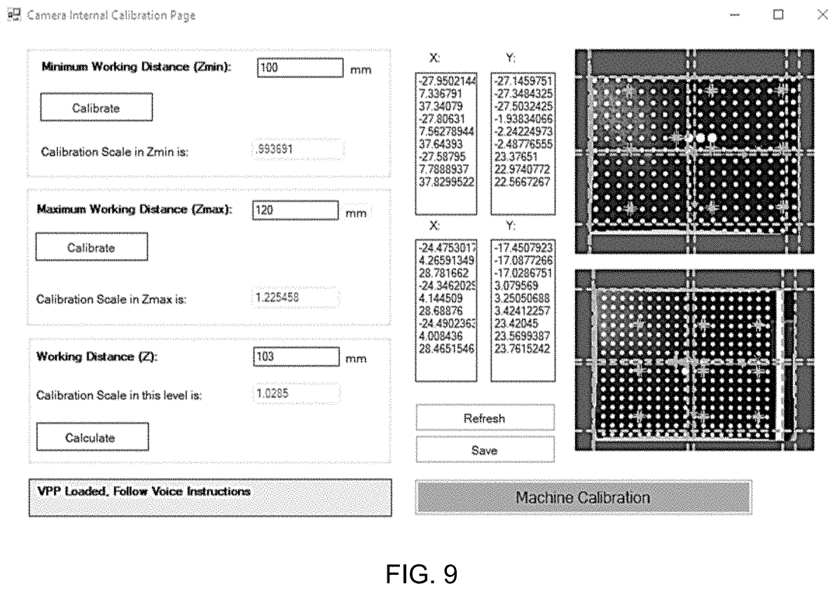

FIG. 9 shows the result of internal and external calibration of camera for working distance 103 mm. First, the scale values for working distances Zₘᵢₙ=100 mm and Zₘₐₓ=120 mm are calculated, and then using linear interpolation equation (3), the scale value for working distance Z=103 mm is determined.

### Robot Workspace Calibration

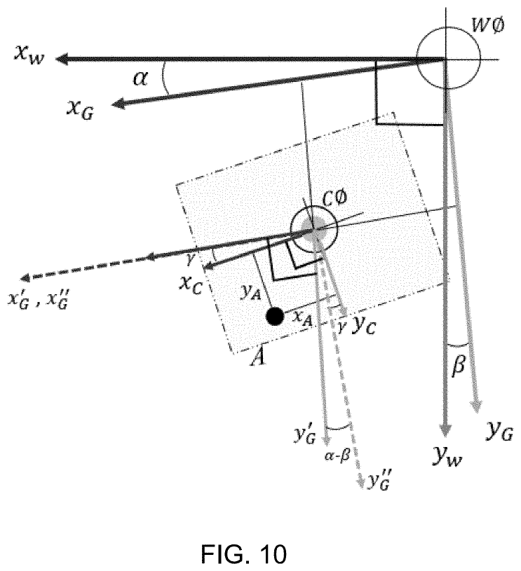

It is assumed that the axes of gantry robot have angular misalignment α and β radians with respect to the world coordinate system in the horizontal plane as shown in FIG. 10. Moreover, the axes are scaled by Sₓ,S_{y} in X-axis and Y-axis, respectively. Here, it is assumed that:
i. The origin of world coordinate system W_{ø} is attached to the origin of the gantry system.
ii. The axes of world coordinate system are parallel to the reference plate AB-AC.
iii. The axes of gantry coordinate system are not perpendicular to each other (axes could be skewed).
iv. Precision-points on reference plate are precisely machined with accuracy 10 μm.
v. Camera is installed with angle γ w.r.t the gantry system (x_{G}−x_{G}) and can be estimated. Camera never rotates while it is moving along X and Y axes.
vi. There is a scale factor in X and Y directions in the gantry system motion.

The gantry robot is calibrated via three precision points A, B, C on the reference plate. To do so, the coordinate systems {C}, {G″}, {G′}, {G} and {W} are established on camera, gantry system, medium coordinate systems and reference plate, respectively, and then transformation matrices are formed from the camera to world coordinate system. The solution for unknown parameters including α, β, γ, Sₓ, S_{y} will be found in an iterative computational formula.

From FIG. 10, it is obvious that the sequence of transformation from camera to world coordinate system is:

{C}→{G″}→{G′}→{G}→{W}

Therefore, the transformation matrix from camera to world coordinate system would be written as:

^{W}T^{C}=^{W} [symbol] ^{G G} [symbol] ^{G′ G′} [symbol] ^{G″ G″} [symbol] ^{C} (4)

### Calculation of X-Axis and Y-Axis Misalignment and Scaling Factor of Gantry System

The transformation from gantry coordinate system {G} to world coordinate system {W} is:

$${ }^{W} {\overleftarrow{T}}^{G} = [ \begin{matrix}cos ( α ) & - s in ( β ) & 0 \\ •sin ( α ) & cos ( β ) & 0 \\ 0 & 0 & 1\end{matrix} ] [ \begin{matrix}{S}_{x} & 0 & 0 \\ 0 & {S}_{y} & 0 \\ 0 & 0 & 1\end{matrix} ] = [ \begin{matrix}{S}_{x} cos ( α ) & - {S}_{y} sin ( β ) & 0 \\ {S}_{x} sin ( α ) & {S}_{y} cos ( β ) & 0 \\ 0 & 0 & 1\end{matrix} ] \qquad ( 5 )$$

Transformation from {G′} to {G} could be written as:

$${ }^{G} {\overleftarrow{T}}^{{G}^{′}} = [ \begin{matrix}1 & 0 & {}_{}^{G}{x}{}_{C φ}^{} \\ 0 & 1 & {}_{}^{G}{y}{}_{C φ}^{} \\ 0 & 0 & 1\end{matrix} ] [ \begin{matrix}1 \text{/} {S}_{x} & 0 & 0 \\ 0 & 1 \text{/} {S}_{y} & 0 \\ 0 & 0 & 1\end{matrix} ] \qquad ( 6 )$$

Transformation from medium coordinate {G″} to {G′} is:

$${ }^{{G}^{′}} {\overleftarrow{T}}^{{G}^{″}} = [ \begin{matrix}1 & - tan ( α - β ) & 0 \\ 0 & sec ( α - β ) & 0 \\ 0 & 0 & 1\end{matrix} ] \qquad ( 7 )$$

Transformation from camera coordinate system {C} to {G″} is:

$${ }^{{G}^{″}} {\overleftarrow{T}}^{C} [ \begin{matrix}cos γ & - s in γ & 0 \\ sin γ & cos γ & 0 \\ 0 & 0 & 1\end{matrix} ] \qquad ( 8 )$$

The commanded position of the gantry that locates the center of camera's image at the current position (CØ) is assumed to be ^{G}P_{CØ}:

$${ }^{G} {P}_{C φ} = [ \begin{matrix}{ }^{G} {x}_{C φ} \\ { }^{G} {y}_{C φ} \\ 1\end{matrix} ] \qquad ( 9 )$$

It is assumed that the calibrated output of the camera for the object's reference point (O) in the camera coordinates (^{C}Pₒ) is available as:

$${ }^{C} {P}_{o} = [ \begin{matrix}{ }^{C} {x}_{o} \\ { }^{C} {y}_{o} \\ 1\end{matrix} ] \qquad ( 10 )$$

The same point (Pₒ) in the world coordinate system could be expressed as ^{W}Pₒ and obtained as:

^{W}Pₒ=(^{W} [symbol] ^{G G} [symbol] ^{G′ G′} [symbol] ^{G″ G″} [symbol] ^{C})^{C}Pₒ (11)

^{W} [symbol] ^{C} represents the transformation matrix that maps the position of the object's reference point from the camera coordinate system (^{C}Pₒ) to the world coordinate system (^{W}Pₒ) as:

^{W} [symbol] ^{C}=^{W} [symbol] ^{G G} [symbol] ^{G′ G′} [symbol] ^{G″ G″} [symbol] ^{C} (12)

The displacement and the absolute position that the gantry needs to be moved in order to allow the camera see the object's reference point at the center of its image will be ^{G′}Pₒ and ^{G}Pₒ, respectively:

Displacement of the gantry: ^{G′}Pₒ=(^{G′} [symbol] ^{G″ G″} [symbol] ^{C})^{C}Pₒ

New position of the gantry: ^{G}Pₒ=(^{G} [symbol] ^{G′ G′} [symbol] ^{G″ G″} [symbol] ^{C})^{C}Pₒ (13)

Moreover, once we know where the reference point is located in the world coordinate system (^{W}Pₒ) the calibration matrix (K=(^{W} [symbol] ^{G})⁻¹) will provide the position needs to be commanded to the gantry to locate the center of camera image at ^{G}P₀.

^{G}Pₒ=K^{W}Pₒ (14)

Let's expand the ^{G}Pₒ=^{G} [symbol] ^{C C}Pₒ as following:

$$[ \begin{matrix}{ }^{G} {x}_{o} \\ { }^{G} {y}_{o} \\ 1\end{matrix} ] = [ \begin{matrix}{ }^{G} {x}_{C ∅} + 1 \text{/} {S}_{x} [ {(}^{C} {x}_{o} cos ( γ ) - {}_{ }^{C}{y}{}_{o}^{} sin ( γ ) ) - tan ( α - β ) {(}^{C} {x}_{o} sin ( γ ) + {}_{ }^{C}{y}{}_{o}^{} cos ( γ ) ) ] \\ { }^{G} {y}_{C φ} + 1 \text{/} {S}_{y} [ sec ( α - β ) {(}^{C} {x}_{o} sin ( γ ) + {}_{ }^{C}{y}{}_{o}^{} cos ( γ ) ) ] \\ 1\end{matrix} ] \qquad ( 15 )$$

And also, let's expand the ^{W}Pₒ=^{W} [symbol] ^{G G}Pₒ:

$$[ \begin{matrix}{ }^{W} {x}_{o} \\ { }^{W} {y}_{o} \\ 1\end{matrix} ] = [ \begin{matrix}{S}_{x} cos ( α ) & - {S}_{y} sin ( β ) & 0 \\ {S}_{x} sin ( α ) & {S}_{y} cos ( β ) & 0 \\ 0 & 0 & 1\end{matrix} ] [ \begin{matrix}{ }^{G} {x}_{o} \\ { }^{G} {y}_{o} \\ 1\end{matrix} ] \qquad ( 16 )$$

For each of the three precision points on the reference plate, one needs to substitute o with A, B, or C. Let's detect each of the A, B, or C points on the reference plate. The gantry is located around the top of the point, where the center of camera image is located at ^{G}P_{CØ|@A}, ^{G}P_{CØ|@B}, or ^{G}P_{CØ|@C} and the relative position of each point at the camera output is obtained as ^{C}P_{A}, ^{C}P_{B}, or ^{C}P_{C}.

Let's put the three equations of ^{W}Pₒ=^{W} [symbol] ^{G G}Pₒ for o=A, B, or C together:

$$[ \begin{matrix}{}_{}^{W}{x}{}_{A}^{} & {}_{}^{W}{x}{}_{B}^{} & {}_{}^{W}{x}{}_{C}^{} \\ {}_{}^{W}{y}{}_{A}^{} & {}_{}^{W}{y}{}_{B}^{} & {}_{}^{W}{y}{}_{C}^{} \\ 1 & 1 & 1\end{matrix} ] = [ \begin{matrix}{S}_{x} cos ( α ) & - {S}_{y} sin ( β ) & 0 \\ {S}_{x} sin ( α ) & {S}_{y} cos ( β ) & 0 \\ 0 & 0 & 1\end{matrix} ] [ \begin{matrix}{}_{}^{G}{x}{}_{A}^{} & {}_{}^{G}{x}{}_{B}^{} & {}_{}^{G}{x}{}_{C}^{} \\ {}_{}^{G}{y}{}_{A}^{} & {}_{}^{G}{y}{}_{B}^{} & {}_{}^{G}{y}{}_{B}^{} \\ 1 & 1 & 1\end{matrix} ] \qquad ( 17 )$$

We could represent ^{W} [symbol] ^{G} in the following form:

$${}_{}^{W}{\overleftarrow{T}}{}_{}^{G} [ \begin{matrix}{H}_{1} & {H}_{2} & 0 \\ {H}_{3} & {H}_{3} & 0 \\ 0 & 0 & 1\end{matrix} ] \qquad ( 18 )$$

After simplification of equation it becomes:

$$[ \begin{matrix}{}_{}^{W}{x}{}_{A}^{} & {}_{}^{W}{x}{}_{B}^{} & {}_{}^{W}{x}{}_{C}^{} \\ {}_{}^{W}{y}{}_{A}^{} & {}_{}^{W}{y}{}_{B}^{} & {}_{}^{W}{y}{}_{C}^{}\end{matrix} ] = [ \begin{matrix}{H}_{1} & {H}_{2} \\ {H}_{3} & {H}_{4}\end{matrix} ] [ \begin{matrix}{}_{}^{G}{x}{}_{A}^{} & {}_{}^{G}{x}{}_{B}^{} & {}_{}^{G}{x}{}_{C}^{} \\ {}_{}^{G}{y}{}_{A}^{} & {}_{}^{G}{y}{}_{B}^{} & {}_{}^{G}{y}{}_{C}^{}\end{matrix} ] \qquad ( 19 )$$

Subtracting ^{W}P_{A} from all columns on both side, it yields:

$$[ \begin{matrix}0 & {}_{}^{W}{x}{}_{B}^{} - {}_{}^{W}{x}{}_{A}^{} & {}_{}^{W}{x}{}_{C}^{} - {}_{}^{W}{x}{}_{A}^{} \\ 0 & {}_{}^{W}{y}{}_{B}^{} - {}_{}^{W}{y}{}_{A}^{} & {}_{}^{W}{y}{}_{C}^{} - {}_{}^{W}{y}{}_{A}^{}\end{matrix} ] = [ \begin{matrix}{H}_{1} & {H}_{2} \\ {H}_{3} & {H}_{4}\end{matrix} ] [ \begin{matrix}0 & {}_{}^{G}{x}{}_{B}^{} - {}_{}^{G}{x}{}_{A}^{} & {}_{}^{G}{x}{}_{C}^{} - {}_{}^{G}{x}{}_{A}^{} \\ 0 & {}_{}^{G}{y}{}_{B}^{} - {}_{}^{G}{y}{}_{A}^{} & {}_{}^{G}{y}{}_{C}^{} - {}_{}^{G}{y}{}_{A}^{}\end{matrix} ] \qquad ( 20 )$$

Since

$$[ \begin{matrix}{}_{}^{W}{x}{}_{B}^{} - {}_{}^{W}{x}{}_{A}^{} & {}_{}^{W}{x}{}_{C}^{} - {}_{}^{W}{x}{}_{A}^{} \\ {}_{}^{W}{y}{}_{B}^{} - {}_{}^{W}{y}{}_{A}^{} & {}_{}^{W}{y}{}_{C}^{} - {}_{}^{W}{y}{}_{A}^{}\end{matrix} ] = [ \begin{matrix}{d}_{x} & 0 \\ 0 & {d}_{y}\end{matrix} ] ,$$

thus:

$$[ \begin{matrix}{H}_{1} & {H}_{2} \\ {H}_{3} & {H}_{4}\end{matrix} ] = [ \begin{matrix}{d}_{x} & 0 \\ 0 & {d}_{y}\end{matrix} ] {( [ \begin{matrix}{}_{}^{G}{x}{}_{B}^{} - {}_{}^{G}{x}{}_{A}^{} & {}_{}^{G}{x}{}_{C}^{} - {}_{}^{G}{x}{}_{A}^{} \\ {}_{}^{G}{y}{}_{B}^{} - {}_{}^{G}{y}{}_{A}^{} & {}_{}^{G}{y}{}_{C}^{} - {}_{}^{G}{y}{}_{A}^{}\end{matrix} ] )}^{- 1} \qquad ( 21 )$$

Once H₁, H₂, H₃ and H₄ are obtained, we can obtain Sₓ, S_{y}, α, and β as follows:

$${S}_{x} = \sqrt{{H}_{1}^{2} + {H}_{3}^{2}} \\ {S}_{y} = \sqrt{{H}_{2}^{2} + {H}_{4}^{2}} \\ α = Arc Tan ( \frac{{H}_{3}}{{H}_{1}} ) \\ β = Arc Tan ( \frac{- {H}_{2}}{{H}_{4}} ) \qquad ( 22 )$$

### Camera Installation

In the gantry robot, the downward looking camera (DLC) is installed with angle γ₁ radians with respect to X-axis of the gantry system as shown in FIG. 4. In order to measure the DLC camera installation angle, we take a snapshot from the current position of the camera and then move the gantry system along the X-axis for “a” mm and take another snapshot at the second position. Then, we look at the same feature at both snapshots.

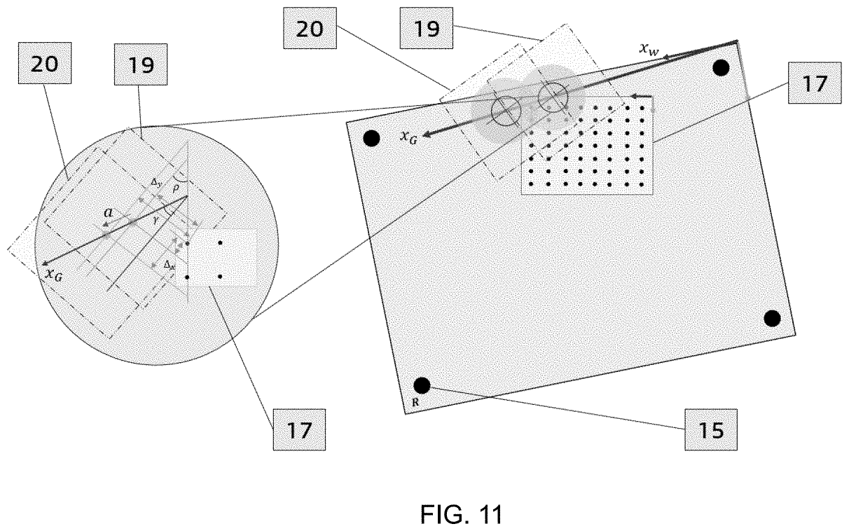

From the FIG. 11, the installation angle of camera could be calculated through the following equations:

$$sin {γ}_{1} = \frac{{Δ}_{y}}{10 \text{,} 000 µm} \\ cos {γ}_{1} = \frac{{Δ}_{x}}{10 \text{,} 000 µm} \qquad ( 23 )$$

where Δₓ and Δ_{y} as shown in FIG. 11, are relative distance of a dot-point on Dot-grid and the center of the camera in X and Y directions.

To have accurate measurement of camera angle, it is better to have error analysis on both equations and select the equation with less error.

Let's assume ε_{G} is gantry accuracy along X-axis and it is 10 μm, and ε_{c} is camera accuracy and it is 10 μm/pixel, and γ^{t} is the true value of γ which is 0.5°. And also, a is the linear motion of gantry system along the X-axis for 15000 μm. Therefore, the deviation in X and Y direction due to camera angle would be:

$${Δ}_{y}^{t} = a sin {γ}^{t} = 15000 \times sin ( 0.5 ) = 130.9 µm \\ {Δ}_{x}^{t} = a cos {γ}^{t} = 15000 \times cos ( 0.5 ) = 14999.4 µm \\ sin {γ}_{1} = \frac{{Δ}_{y} \pm {ɛ}_{c}}{a \pm {ɛ}_{G}} = \{ \begin{matrix}\frac{130.9 µm + 10 µm}{15000 µm - 10 µm} = 0.0094 ⇒ {γ}_{1} = 0.53 {8}^{o} ⇒ {ɛ}_{γ 1} = 0.03 {8}^{o} \\ \frac{130.9 µm - 10 µm}{15000 µm + 10 µm} = 0.0080 ⇒ {γ}_{1} = 0.45 {8}^{0} ⇒ {ɛ}_{γ 1} = 0.04 {2}^{o}\end{matrix} \\ cos {γ}_{2} = \frac{{Δ}_{x} \pm {ɛ}_{c}}{a \pm {ɛ}_{G}} = \{ \begin{matrix}\frac{14999.4 µm + 10 µm}{15000 µm - 10 µm} = 1.0012 ⇒ {γ}_{2} = invalid \\ \frac{14999.4 µm - 10 µm}{15000 µm + 10 µm} = 0.9986 ⇒ {γ}_{2} = 3.00 {2}^{o} ⇒ {ɛ}_{γ 2} = 2.50 {2}^{o}\end{matrix} \qquad ( 24 )$$

Now the question is that, what is the effect of camera angle measurement error on the accuracy of camera reading in the second snapshot:

$${ɛ}_{c 2} = {ɛ}_{γ 1} \times \frac{π}{180} \times a = 0.04 {2}^{o} \times \frac{π}{180} \times 15000 = 11 µm \qquad ( 25 )$$

The camera accuracy in the second snapshot becomes:

max{ε′_{c2}}=ε_{c2}=ε_{c}=21 μm (26)

### Tool Calibration

The main problem in tool calibration is finding the distances δₓ, δ_{y}. To determine the location of the tool head with respect to the camera FOV center, a precisely machined tapered object called calibration work piece is manufactured for pick and placing, and finding the center of tool head with respect to the upward looking camera.

### Finding the Distance Between DLC Camera Center and Tool Head Center

To calibrate tooling system via machine vision we need to fabricate an object Q such that it is precisely picked up by the tool. First, we pick up the tool from the arbitrary point and then move and place the object on a magnetic plate to make sure the part never moves along the X-Y axes while the tool head is releasing the object, and then save the current location of camera center [0 0 1]^{T} in camera coordinate, G[x_{C01} Y_{C01} 1]^{T}.

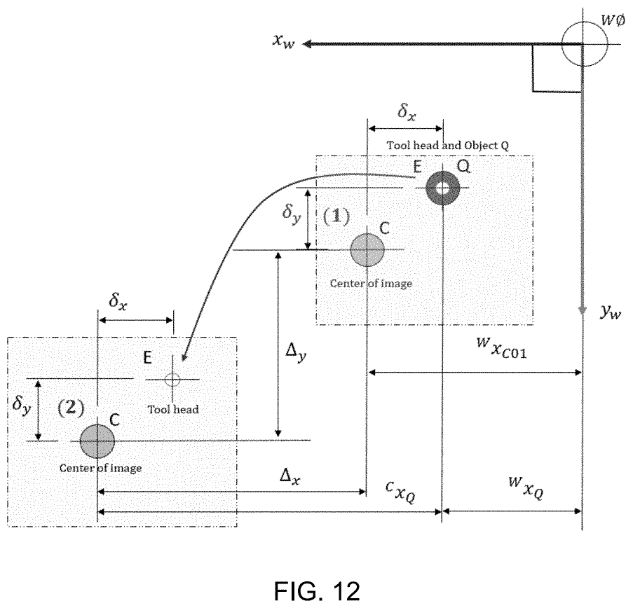

As shown in FIG. 12, we need to move the camera center along the X-Y axis for Δx, Δy such that to see the Q in camera image. We capture an image and find the Q center in camera coordinate system (^{C}x_{Q}, ^{C}y_{Q}), and then transform it to the gantry coordinate to find the offset between camera center and tool head center in gantry system.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A model-based mathematical method for calibration of a gantry robot and a tool via a dual camera vision system comprising:
(i) Camera Internal and External Calibration (ULC and DLC);
(ii) Camera Installation;
(iii) Robot Workspace Calibration; and
(iv) Tool Calibration.
